(19) United States
(12) Patent Application Publication
(10) Pub. No.: US 2008/0209483 A1
(43) Pub. Date: Aug. 28, 2008

(54) System And Method For Providing Rss Content In A Broadcast System

(75) Inventors: Johannes H.M. Lemmers, Reek (NL); Siarhei Dudzin, Eindhoven (NL); Michiel J. Christianen, Zundert (NL); Michael Haulussy, Elst (NL); Peter Boon, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,025

(22) PCT Filed: Feb. 20, 2006
(86) PCT No.: PCT/IB06/50551

§ 371 Date: Aug. 24, 2007

Related U.S. Application Data
(60) Provisional application No. 60/656,124, filed on Feb. 24, 2005.

(51) Int. Cl. H04N 7/173

(52) U.S. Cl. 725/105

(57) ABSTRACT

A system and method for providing RSS content in a broadcast system. According to one embodiment, a method for providing RSS content in a broadcast system comprises the acts of: periodically retrieving, at a broadcast station (102), RSS content from at least one remote source (110) storing the RSS content; parsing the retrieved RSS content to generate transformed RSS content; formatting the transformed RSS content; and transmitting the formatted transformed RSS content from the broadcast station (102) to a plurality of receivers (106). According to another embodiment, a “user initiated retrieval” method retrieves RSS content from at least one remote source (110) storing the RSS content only in response to a user initiated request.

The present invention relates generally to communication systems and in particular to systems and methods for making RSS content available to broadcast station subscribers.

Rich Site summary (RSS), also known as RDF Site Summary, is a simple and well established XML (Extensible Markup Language) format for syndicating headlines. It is a content format enabling site owners, and other content producers, to make information available to web users. For example, RSS allows one web site to acquire or display material from another site, or an application called an aggregator to show a web user what information is available for retrieval. As is well known, the RSS format is a simple and well established XML (Extensible Markup Language) format for syndicating headlines. Presently, RSS enables site owners, and other content producers, to make the RSS content available only to web users.

Given the limited availability of RSS content to subscribers beyond web users, it would be desirable to make the RSS content more widely available to the millions of subscribers of television broadcast systems throughout the world. The RSS content could be incorporated into both proprietary and non-proprietary broadcast systems, such as the proprietary OpenTV system or the non-proprietary MHP system (the Multimedia Home Platform, issued by DVB, the Digital Video Broadcasting Project) and the non-proprietary OCAP system (the OpenCable Application Platform). The RSS content could be made available to the broader subscriber population either as a standalone application, such as the well-known teletext application or as a data component of a broadcast application.

A system and method are described for providing RSS content in a broadcast system. More particularly, the present invention extends the availability of RSS content to subscribers of TV broadcast systems such as, for example, MHP and OCAP.

According to one aspect of the present invention, a method for providing RSS content in a broadcast system comprises the acts of: periodically retrieving, at a broadcast station, RSS content from at least one remote source storing the RSS content; parsing the retrieved RSS content to generate transformed RSS content; formatting the transformed RSS content; and transmitting the formatted RSS content from the broadcast station to a plurality of receivers.

According to another aspect of the present invention, a method for providing RSS content in a broadcast system comprises the acts of: transmitting a broadcast application from a broadcast station to a plurality of receivers; receiving a request at the broadcast station from one of the plurality of receivers for RSS content; retrieving the requested RSS content from at least one remote source responsive to the receiver request; transmitting the retrieved RSS content from the broadcast station to the requesting receiver; parsing the retrieved RSS content at the requesting receiver to generate transformed RSS content; formatting the transformed RSS content at the requesting receiver to generate formatted RSS content; and executing said broadcast application (132) to display the transmitted RSS content.

In the various embodiments described herein, the acts of parsing and formatting the RSS content may be performed entirely on the broadcaster side, receiver side or performed in part on broadcaster side and in part on the receiver side.

According to another aspect of the invention, a system for providing RSS content in a broadcast system comprises: a broadcaster comprising: a controller configured to control the operations of the broadcaster; an RSS retriever configured to periodically retrieve RSS information and to parse the RSS content to generate transformed RSS content; a formatter configured to format the transformed RSS content to generate formatted transformed RSS content; a plurality of receivers, each receiver comprising: an MHP device configured to execute an MHP application; and a display configured to display an output of the MHP application to at least one end-user.

According to yet another aspect of the invention, a system for providing RSS content in a broadcast system comprises: a broadcaster comprising: a controller configured to control a broadcaster comprising: a controller configured to control the operations of the broadcaster; an RSS retriever configured to periodically retrieve RSS information and to parse the RSS content to generate transformed RSS content; a formatter configured to format the transformed RSS content to generate formatted transformed RSS content; a plurality of receivers, each receiver comprising: an MHP device configured to execute an MHP application; and a display configured to display an output of the MHP application to an end-user.

The foregoing features of the present invention will become more readily apparent and may be understood by referring to the following detailed description of an illustrative embodiment of the present invention, taken in conjunction with the accompanying drawings, where:

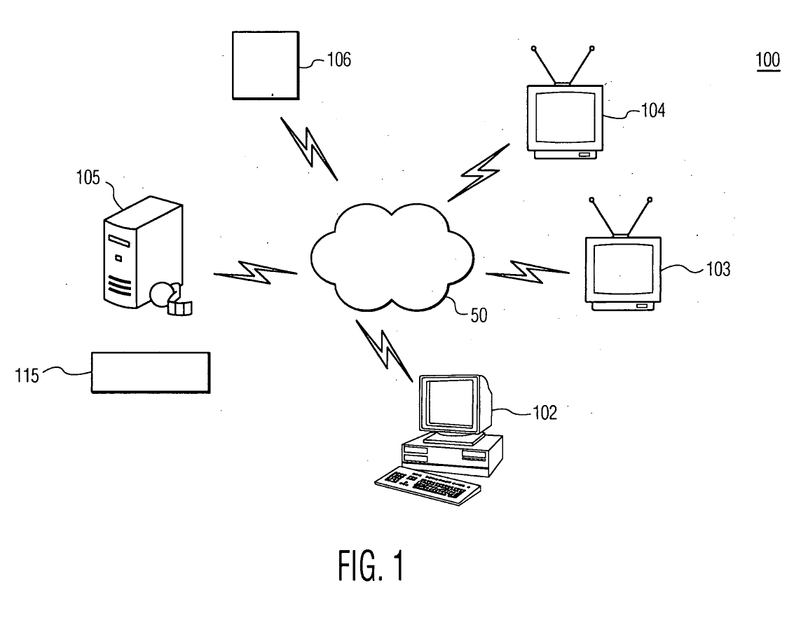

FIG. 1 illustrates a broadcast communication system incorporating the system of the invention according to one embodiment;

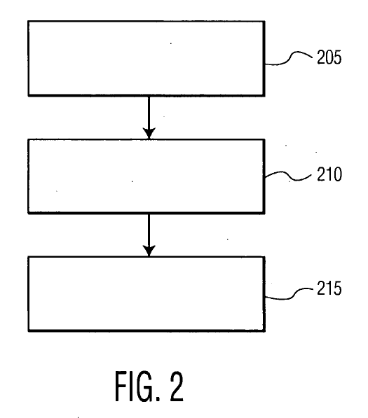

FIG. 2 illustrates a sequence diagram that describes in detail the operations performed at the central broadcast station in accordance with the embodiment illustrated in FIG. 1;

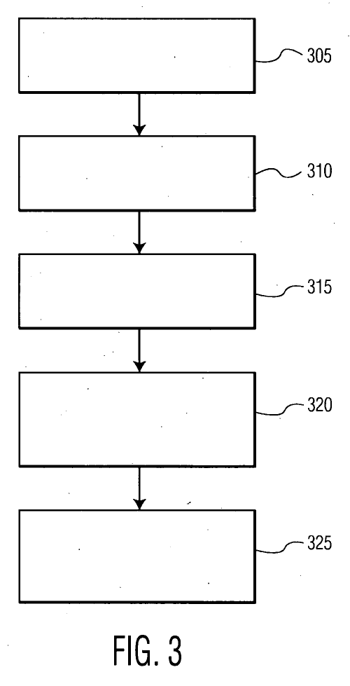

FIG. 3 illustrates a broadcast communication system incorporating the system of the invention according to one embodiment;

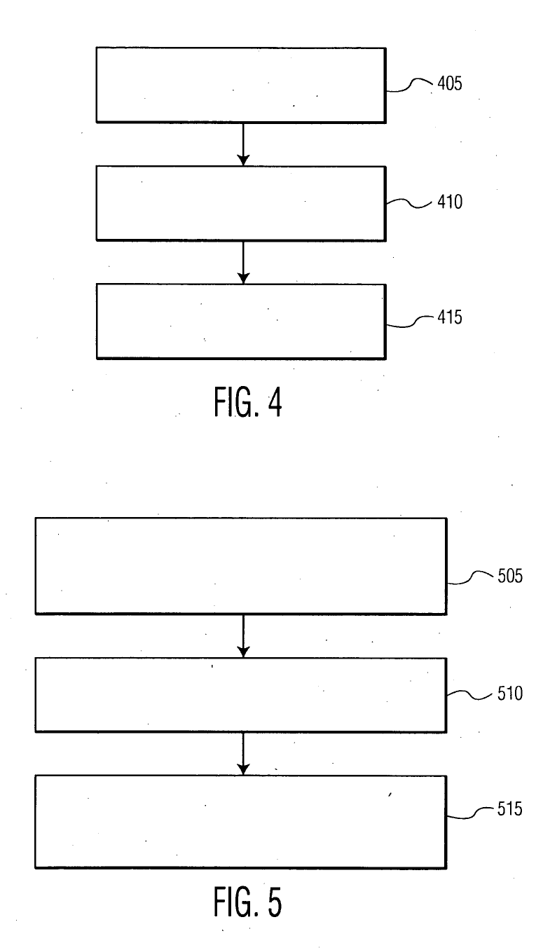

FIG. 4 illustrates a sequence diagram that describes in detail the operations performed at the central broadcast station in accordance with the embodiment illustrated in FIG. 1;

FIG. 5 is an illustration of an exemplary display of enhancement content that may be displayed to an end user of a television broadcast system in accordance with the embodiment illustrated in FIG. 1; and

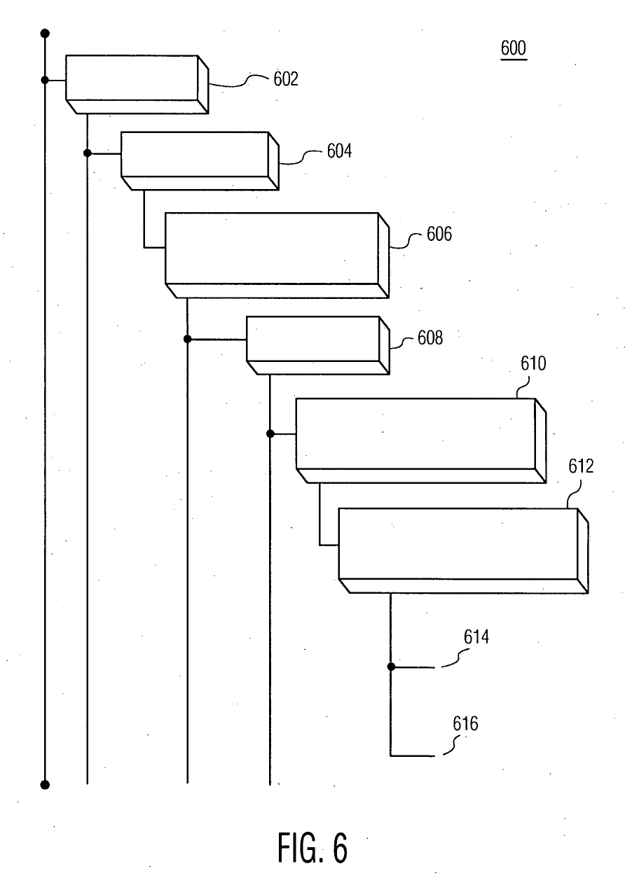

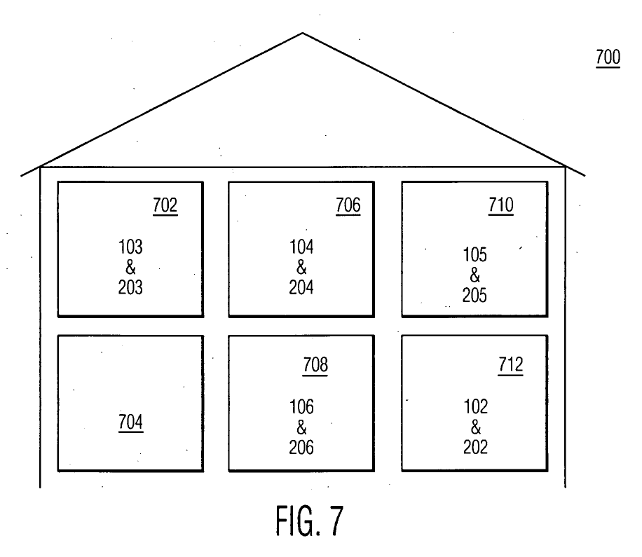

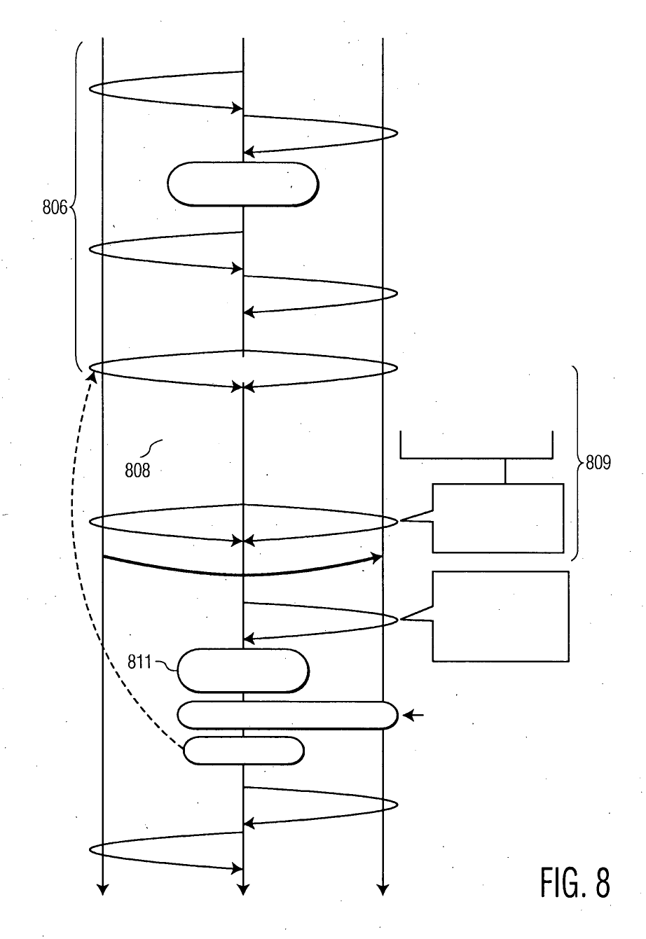

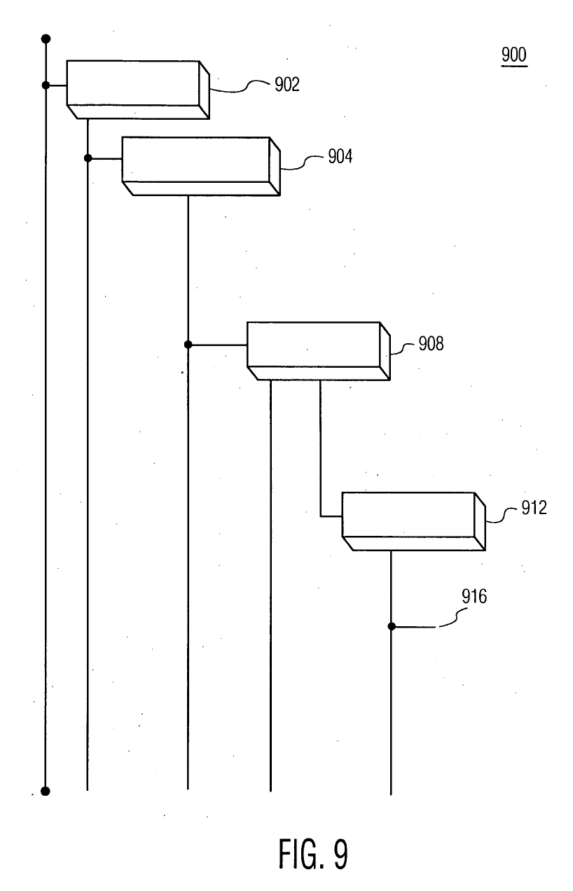

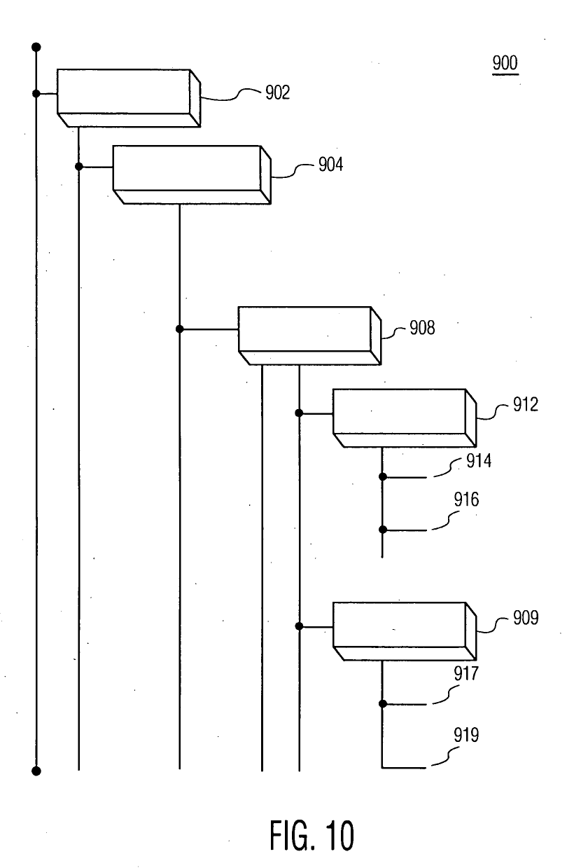

FIG. 6 is an illustration of an exemplary display shown to an end user upon selecting the “RSS information sources” link at the display of FIG. 5.

Although the following detailed description contains many specifics for the purpose of illustration, one of ordinary skill in the art will appreciate that many variations and alterations to the following description are within the scope of the invention. Accordingly, the following preferred embodiment of the invention is set forth without any loss of generality to, and without imposing limitations upon, the claimed invention

The block diagrams of FIG. 1 and show the architecture, functionality, and operation of various embodiments of the present invention. Each block may represent in whole or in part a module, segment, or portion of code that comprises one or more executable instructions to implement the specified logical function(s). Each block may represent a circuit or a number of interconnected circuits to implement the specified logical function(s).

Embodiments of the present invention will allow subscribers of broadcast systems to receive RSS content.

Turning now to FIG. 1, therein is depicted a broadcast system 100 including elements of the invention. Broadcast system 100 illustrates a system embodiment of the invention referred to herein as “centralized periodic RSS retrieval”. In accordance with the “centralized periodic RSS retrieval” method, RSS content is periodically collected at a central broadcast station 102 from a number of remote servers storing RSS content and distributed to a plurality of receivers 106 who subscribe to the broadcast service.

The embodiment of FIG. 1 operates in accordance with the MHP broadcast protocol. It should be understood, however, that the embodiments described herein are not limited to a particular broadcast protocol, such as the MHP broadcast protocol of FIG. 1, but is more widely applicable to a number of broadcast protocols including, for example, OCAP, Open-TV and MS-TV, as will be described.

Broadcast System 100 includes a central broadcast station 102, a first network 109 for connecting the central broadcast station 102 to a plurality of receivers 106, two of which are shown and a second network 104 for connecting the central broadcast station 102 to a plurality of remote RSS servers 110.

The central broadcast station 102 comprises a controller 120 configured to control the operations of the central broadcast station 102, an RSS retriever 122 configured to periodically retrieve the RSS content from the plurality of remote RSS servers 110. The RSS retriever 122 being further configured to parse the RSS content retrieved from the remote RSS servers 110 to generate transformed RSS content. The RSS content is transformed by the RSS retriever 122 into a format that is compatible with software of the broadcast system. The central broadcast station further comprises a data repository 128 which stores a list of URLs corresponding to the network addresses of the remote RSS servers 110, a formatter 124 configured to receive the transformed RSS content from the RSS retriever 122 and add layout information to the transformed content including position information and/or color information and/or graphic information and an MHP Generator 130 which receives as a first input, the formatted RSS content output from the formatter 124, and receives as a second input, an MHP application 132 operable to display the formatted RSS content.

Networks 104 and 109 may comprise a cable, terrestrial or wireless network or combinations thereof.

The Remote RSS servers 110 represent generally any server storing RSS content (i.e., “feeds”) and capable of presenting interfaces and services in response to requests from the RSS retriever module 122 of the central broadcast station 102. The modifying term “remote” is meant only to help the reader distinguish a particular component from the other components of Broadcast system 100.

It is noted that the central broadcast station can include more than one RSS retriever 122, more than one database 128 and more than one MHP application 132.

The receivers 106 comprise a display 108 and an MHP device 107. The MHP device 107 is configured to process MHP applications for display to end users on display 108. The receivers 106 may comprise a set-top box, a personal computer, an interactive television, or other equipment operable to process television signals and, other information, such as control information and program guides. Display units 108 may comprise televisions, computer monitors, or other devices operable to display video images.

The MHP application 132 is configured to incorporate the RSS content as input data to allow end users to select and view the RSS content at the receivers 106.

In an alternative embodiment, MHP application 132 may be pre-stored at the receivers 106, in which case, only the formatted RSS content is required to be transmitted from the central broadcast stations 102 to allow end users to select and view the RSS content at the receivers 106.

In certain embodiments, the acts of parsing and formatting the RSS content could be performed partially on the broadcast side and partially on the client side or entirely on the client side.

Referring now to FIG. 2, a sequence diagram is shown describing the operations performed at the central broadcast station 102 under control of controller 120 in accordance with the embodiment illustrated in FIG. 1 (i.e., “centralized periodic RSS retrieval”).

At step [1]—triggerUipdateRSSContent( )—A timing module (not shown) resident in the central broadcast station 102, periodically triggers controller 120 to initiate a sequence of data collection to collect RSS content from the plurality of remote RSS servers 110.

At step [2]—retrieveNewRssContent( )—In response to the trigger signal, the controller 120 sends an activation signal to the RSS retriever module 122 to retrieve the RSS content from the plurality of remote RSS servers 110.

At step [3]—retrieveListRssFeeds( )—In response to the activation signal issued from controller 120, the RSS retriever module 122 accesses data repository 128 to retrieve a URL list identifying URL addresses of the plurality of remote RSS servers 100 to be accessed to retrieve the RSS content.

The following steps (4 & 5) are repeated for each remote RSS server 110 to be accessed by RSS retriever module 122.

At step [4]—requestUrl(rssUrl)—Using the URL list, the RSS retriever module 122 accesses the I^{th} RSS server 110 to request RSS content stored there.

At step [5]—parseRssContent(rssContent)—Upon retrieving RSS content from the i^{th} RSS server 110, the RSS retriever module 122 parses the RSS content to generate transformed RSS content. The transformed RSS content is in a format that is compatible with the broadcast system software.

At step [6]—formatRawRssData(allRawRssData)—The transformed RSS content is output to the formatter 124 to add layout information. The layout information could include adding position information and/or color information and/or graphic information or other types of well known layout information.

An optional feature of the embodiments described herein is that formatter 124 may be further configured is to determine whenever the RSS content (i.e., an XML RSS feed) which is output from the RSS Retriever, is identical to the RSS content collected in the previous collection (retrieval) cycle. When this occurs, the formatter 124 can bypass the formatting operation and use the previously formatted RSS content.

At step [7]—publishRssContent(finalContent—As is well known, in accordance with the DVB/MHP protocol, The MHP Generator 130 constantly broadcasts a filesystem, including at least one MHP application in a carousel format. Whenever new formatted data is output from formatter 124, the new formatted data (partly) replaces an old data set in the MHP application 132 with which the formatted data is to be combined. It should be understood that an MHP application consists of code-files and data-files. Whenever new formatted data is output from formatter 124, a portion of the data-files is replaced during the update.

In an alternative embodiment, MHP application 132 is resident at the clients 106. In this embodiment, only the formatted transformed RSS data, which is output from the formatter 124, is transmitted over network 109 to be combined with MHP application 132, which is resident at the receiver 106.

In certain embodiments, the act of parsing and/or formatting could be performed on the broadcast side or the client side.

Turning now to FIG. 3, therein is depicted a broadcast system 300. System 300 illustrates an embodiment referred to herein as “receiver initiated retrieval”. The embodiment of FIG. 3 operates in accordance with the MHP broadcast protocol. It should be understood, however, that the embodiments described herein are not limited to the MHP broadcast protocol but have general applicability to a wide variety of broadcast protocols including, for example, OCAP, Open-TV and MS-TV.

System 300 includes a central broadcast station 102, a first network 109 connecting the central broadcast station to a plurality of remote RSS servers 110, a second network 106 connecting the central broadcast station 102 to a plurality of receivers 106, two of which are shown.

The central broadcast station 102 includes a request handler module 302 configured to retrieve RSS content from the plurality of RSS Servers 110 responsive to requests initiated from the receivers 106. The central broadcast station 102 also includes a number of MHP applications, one of which is shown here, i.e., MHP Application 120, which includes a requester module 306 and a presenter module 308. The requester module 306 of MHP application 120 is configured to compose retrieval requests for RSS content initiated by an end user associated with receiver 106, set up any necessary connections with the central broadcast station 102, send composed retrieval requests to the central broadcast station 102, receive the results of such requests and process the results. The Presenter 308 is configured to provide user interface functionality to display the results of requests made by the requestor module 306, provide an interface to facilitate the entry of URL addresses, by end users, of particular RSS servers 110 into a “favorites list” and display the “favorites list” to end users upon request to allow the end users to select particular RSS servers 110 to receive RSS content. Of course, the end user may also select the URL address of a particular RSS server 110 that is not already on the “favorites list” for inclusion.

The receivers 106 include an MHP receiver 107 configured to execute MHP applications such as MHP Application 120 transmitted from the central broadcast station 102.

It should be understood that in the present embodiment, RSS content is retrieved from the remote RSS servers 110 on the initiative of the end user. This is in contrast tot the embodiment illustrated in FIG. 1 in which RSS content is retrieved periodically. In the present embodiment, whenever an end user decides to issue a request for RSS content, the requestor module 306 composes a retrieval request which is transmitted across network 106 to the request handler 302 at the central broadcast station 102. The request including at least (1) a URL address of an RSS server 110 storing RSS content, and (2) an RSS content identifier identifying a specific RSS “feed” stored on the identified RSS server 110. In response to the request retrieves the requested RSS content via network 104. This process is described in greater detail with reference to the sequence diagram of FIG. 4.

Turning now to FIG. 4, a sequence diagram is shown that describes in detail the operations performed in accordance with the presently described embodiment.

At step [1]—enterNewRssUrl(newRssURl)—On the receiver side 106, the client enters a URL identifier (newRssURl) to the presenter 308 requesting RSS content (i.e., an RSS “feed”).

At step [2]—showRssContent(rssUrlRef)—On the receiver side 106, the client then enters a specific RSS feed (i.e., rssUrlRef) to the presenter 308 to identify the requested RSS content which is stored on an RSS server 110 identified by the client, via the URL identifier, at step 1.

At step [3]—requestRssContent(rssUrl)—On the receiver side 106, the request is passed from the presenter 308 to the requester 306 which is configured to compose a retrieval request to be transmitted to the central broadcast station 102. The retrieval request includes at least the URL identifier (see step 1) and the specific RSS feed (see step 2).

At step [4]—requestRssContent(rssUrl)—The request is passed from the requester 306, via network 106, to the request handler 302 at the central broadcast station 102.

At step [5]—requestUrl(rssUrl)—The request is passed from the request handler module 302 at the central broadcast station 102, via network 104, to the appropriate RSS server 110 as identified in the request (i.e., using the URL parameter supplied by the client).

At step [6]—parseRssXml(rssContent) The RSS server 110 receiving the request returns RSS content (“RSS feed”) in the form of an RSS XML file to the request handler 302. The request handler 302 parses the retrieved RSS XML file to generate transformed RSS content. The transformed RSS content is a format that is compatible with software of the broadcast system.

At step [7]—layoutAndDisplayRssContent(rssContent)—The presenter module 302 layouts and presents the RSS content to the end user.

FIG. 5 is an illustration of an exemplary display of enhancement content that may be displayed to an end user of a television broadcast system in accordance with the embodiment illustrated in FIG. 1. As shown, the enhancement content includes a number of links that may be selected by an end user. In accordance with the system and method of the invention, the user is provided with the option of selecting an “RSS information sources” link 502.

FIG. 6 is an illustration of an exemplary display shown to an end user upon selecting the “RSS information sources” link 502 at the display of FIG. 5. FIG. 6 illustrates two columns of RSS “feeds” 602, 604. The RSS “feeds” 602, 604 represent RSS content that is collected in accordance with the “centralized periodic RSS retrieval” embodiment illustrated in FIG. 1. As stated above, in accordance with the “centralized periodic RSS retrieval” method, RSS content is periodically collected at a central broadcast station 102 from a number of remote servers storing RSS content and distributed to a plurality of receivers 106 who subscribe to the broadcast service.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for providing RSS content in a broadcast system comprising the acts of.
(a) retrieving, at a broadcast station (102), RSS content from at least one remote source (110) storing said RSS content;
(b) parsing said retrieved RSS content to generate transformed RSS content;
(c) formatting said transformed RSS content, and
(d) transmitting the formatted ASS content from the broadcast station (102) to a plurality of receivers (106).

2. The method according to claim 1, wherein said act (a) of retrieving is performed periodically.

3. The method according to claim 1, fiber comprising the act of displaying the formatted RSS content at each of said plurality of receivers (106).

4. The method according to Claim 1, further comprising the acts of:
transmitting a broadcast application (132) to the plurality of receivers (106); and
executing said broadcast application (132) to display said transmitted RSS content.

5. The method according to claim 1, wherein the act of formatting said transformed RSS content comprises adding layout information to said RSS content.

6. The method according to claim 5, wherein the layout information comprises at least position information and/or color information and/or graphic information.

7. The method according to claim 1, wherein the RSS content is in a Resource Description Framework Site Summary CUSS) format.

8. The method according to claim 1, further comprising, prior to act (c), the acts of:
comparing said MSS content retrieved at two sequential periods of periodic retrieval to determine if the RSS content is identical at each period; and
omitting the act of formatting the transformed RSS content when said determination is true.

9. The method according to claim 1, wherein the act of periodically retrieving said RSS content further comprises retrieving, from a data repository (128) at each retrieval period, a pre-stored list of URL addresses of said at least one remote source (110) storing said RSS content.

10. A method for providing RSS content in a broadcast system comprising the acts of
(a) periodically retrieving, at a broadcast station (102), ASS content from at least one remote source (110) storing said RSS content;
(b) parsing said RSS content to generate transformed RSS content;
(e) transmitting the transformed RSS content to a plurality of receivers (106); and
(d) transmitting a broadcast application (132) to the plurality of receivers.

11. The method according to claim 10, further comprising the act of executing said transmitted broadcast application (132).

12. The method according to claim 11, wherein the act of executing said transmitted broadcast application (132) further comprises the acts of:
formatting said transformed RSS content (106), to generate formatted RSS content; and
displaying said formatted RSS content.

13. A method for providing RSS content in a broadcast system comprising the acts of:
(a) periodically retrieving, at a broadcast station (102), RSS content from at least one remote source (110);
(b) transmitting said RSS content to a plurality of receivers (106); and
(c) transmitting a broadcast application (132) to the plurality of receivers (106), said broadcast application (132).

14. The method according to claim 13, further comprising the act of executing said transmitted broadcast application (132).

15. The method according to Clam 13, wherein the act of executing said transmitted broadcast application (132) further comprises the acts of, parsing said transmitted RSS content to generate transformed RSS content, and
formatting said transformed RSS content to generate formatted RSS contest; and
displaying said formatted RSS content.

16. The method according to claim 15, wherein the act of formatting further comprises adding layout information.

17. The method according to claim 16, wherein the layout information comprises position information and/or color information and/or graphic information.

18. A method for providing RSS content in 4 broadcast system comprising the acts of,
(a) receiving a request at the broadcast station (102) from one of said plurality of receivers (106) for RSS content;
(b) retrieving said requested RSS content from at least one remote source (110) responsive to said receiver request;
(c) parsing the retrieved PSS content to generate transformed RSS content;
(d) formatting said transformed RSS content; and
(e) transmitting the transformed RSS content from Me broadcast station to the requesting receiver (106);

19. The method according to claim 18, further comprising the acts of:
transmitting a broadcast application (132) from a broadcast station (110) to the plurality of receivers (106); and
executing said transmitted broadcast application (132) at one of said plurality of receivers to display said formatted RSS content.

20. A method for providing RSS content in a broadcast system comprising the acts of:
(a) receiving a request at the broadcast station (102) from one of said plurality of receivers (106) for RSS content;
(b) retrieving said requested RSS content from at least one remote source (110) responsive to said receiver request;
(c) parsing the retrieved RSS content to generate transformed RSS content;
(d) transmitting the formatted RSS content from the broadcast station to the requesting receiver (106).

21. The method according to claim 20, further comprising the acts of:
transmitting a broadcast application (132) from a broadcast station to a plurality of receivers (106); and
executing said broadcast application (132) to RSS content.

22. The method according to claim 21, wherein the act of executing said transmitted broadcast application (132) filter comprises the acts of:
formatting said transformed RSS content to generate formatted RSS content; and
displaying said formatted RSS content.

23. A method for providing RSS content in a broadcast system comprising the acts of:
(b) receiving a request at the broadcast station (102) from one of said plurality of receivers (106) for RS content;
(b) retrieving said requested RSS content from at least one remote source (110) responsive to said receiver request;
(c) transmitting the formatted RSS content from the broadcast station to the requesting receiver (106).

24. The method according to claim 23, further comprising the acts of:
transmitting a broadcast application (132) from a broadcast station to a plurality of receivers (106); and
executing said broadcast application (132) at one of said plurality of receivers (106).

25. The method according to claim 24, wherein the act of executing said broadcast application (132) further comprises the acts of, parsing said transmitted RSS content to generate transformed RSS content; and
formatting said transformed RSS content to generate formatted RSS content; and
displaying said formatted RSS content.

26. A system (100) for providing RSS content in a broadcast system, the system (100) comprising:
(a) a broadcaster (102) comprising:
a controller (120) configured to control the operations of the broadcaster (102);
an RSS retriever (122) configured to periodically retrieve RSS content, parse the RSS content and generate transformed RSS content;
a formatter (124) configured to format the transformed RSS content and generate formatted RSS content;
(b) a plurality of receivers (106), each receiver (106) comprising:
an MS device (107) configured to execute an application; and
a display configured to display an output of the MB application to an end-user.

27. The system of claim 26, further comprising at least one remote source storing the RSS content.

28. The system of claim 26, further comprising a data repository configured to store a URL list corresponding to remote sources of said RSS content.

29. The system of claim 26, further comprising a transmitter for transmitting the RSS content to said data in the transformed format to the receiver.

30. A system for extending an interactive television application with RSS functionality in an interactive television system, the system comprising:
(a) a broadcaster comprising:
a request handler configured to receive a client request for RSS content and retrieve said requested RSS content
(b) a receiver comprising:
a requester (306) configured to compose retrieval requests for RSS content initiated by an end user and process a return,
a presenter (308) configured to allow the end user to enter a URL address of a particular RSS server (110) storing RSS content of interest to the end user aid present RSS content to the client.

31. The system of claim 30, user, comprising a transmitter for transmitting the transformed RSS content to the receiver.
